(19) United States
(12) Patent Application Publication
(10) Pub. No.: US 2024/0344244 A1
(43) Pub. Date: Oct. 17, 2024

(54) METHOD FOR OPERATING A TEXTILE MACHINE

(71) Applicant: Saurer Spinning Solutions GmbH & Co. KG, Übach-Palenberg (DE)

(72) Inventor: Ulrich Gais, Herdecke (DE)

(73) Assignee: Saurer Spinning Solutions GmbH & Co. KG, Übach-Palenberg (DE)

(21) Appl. No.: 18/630,137

(22) Filed: Apr. 9, 2024

(30) Foreign Application Priority Data
Apr. 11, 2023 (LU) 503899

(51) Int. Cl. D01H 13/32; G06F 3/0482; G06F 3/04847

(52) U.S. Cl. CPC D01H 13/32; G06F 3/0482; G06F 3/04847

(57) ABSTRACT

A method for operating a textile machine, comprising:
providing a retrieval function for a user interface, the user interface comprising a plurality of interface elements that are called up for outputting machine parameters and/or settings of the textile machine and/or for input by a user in order to operate the textile machine, wherein each of the interface elements is assigned a designation, wherein a retrieval of the designations is provided by the retrieval function on the basis of a retrieval specification in order to determine the designations that correspond to the retrieval specification, the retrieval specification being defined by the user,
initiating an output of the designations via the at least one user interface for selection by the user; and
providing a navigation function for the at least one user interface, wherein the navigation function calls up the interface element to which the designation selected by the user is assigned.

The present invention relates to a method for operating a textile machine. Further, the invention relates to a system, a computer program and an apparatus for this purpose.

### PRIOR ART

In the prior art, graphical user interfaces are increasingly used to operate textile machines, i.e., to control and monitor textile machines. These user interfaces provide the user with a visual representation of the machine states and the tasks to be performed. User interfaces can comprise different functions, such as setting machine parameters, monitoring machine states, and displaying alarm messages. In this case, interface elements can be provided for the functions, which are graphically displayed for interaction with the user. Furthermore, the user interfaces can generally be easily adapted to the needs of the user in order to ensure increased user-friendliness.

Setting machine parameters can require the entry of a large number of setting and data values. Due to the large number of interface elements of the user interface provided for these inputs and outputs, navigation can be difficult and time-consuming if the user has little experience and prior knowledge. The user therefore needs to know where to find the corresponding interface elements.

Therefore, it is an object of the present invention to at least partially eliminate the disadvantages described above. In particular, it is an object of the present invention to propose an improved solution for operating a textile machine.

### DISCLOSURE OF THE INVENTION

Objects of the invention are a method having the features of claim 1, a system having the features of claim 13, a computer program having the features of claim 14 and an apparatus having the features of claim 15. Further features and details of the invention are apparent from the respective subclaims, the description and the drawings. Features and details described in connection with the method according to the invention naturally also apply in connection with the system according to the invention, the computer program according to the invention along with the apparatus according to the invention, and vice versa in each case, such that, with regard to the disclosure concerning the individual aspects of the invention, reference is or can always be made mutually.

The subject matter of the invention is in particular a method for monitoring and/or operating a textile machine. For this purpose, the method can comprise the following steps, which can be executed sequentially in the specified order and/or repeatedly and/or automatically:
providing a retrieval function for at least one, preferably graphical, user interface, abbreviated GUI, wherein the at least one user interface can comprise a plurality of interface elements that are called up for outputting machine parameters and/or settings of the textile machine and/or for input by a user in order thereby to monitor and/or operate the textile machine, wherein each of the interface elements is assigned a designation, wherein a retrieval, in particular a search, of the designations can be provided by the retrieval function on the basis of a retrieval specification in order to determine the designations that correspond to the retrieval specification, preferably by checking the designations for correspondence to the retrieval specification, wherein the retrieval specification is preferably defined by the user,
initiating an output of the determined designations via the at least one user interface for selection by the user, preferably in order to allow the user to select the designation whose interface element the user would like to call up,
providing a navigation function for the at least one user interface, wherein the navigation function calls up the interface element to which the designation selected by the user is assigned.

The invention thus makes it possible to specifically find and directly select an input or display in the user interface. The textile machine can, for example, be designed as a rotor spinning machine. This machine is characterized, for example, in that the fibers are brought together to form a thread by rotating a rotor. Another possibility is to design the textile machine as a ring spinning machine. Said ring spinning machine uses, for example, a ring-shaped element in order to connect the fibers to form a thread. Furthermore, the textile machine can be designed as an air spinning machine. In this case, it can be provided that an air flow is used to connect the fibers and form them into a thread. The machine parameters of the textile machine can comprise at least one of the following parameters: the spindle speed, the yarn fineness, the number of spindles per machine, the rotational speed of the spindle, the pretension of the thread, the setting of the rollers or roller groups that guide and tension the thread, the setting of the thread tension and guide. These parameters can vary according to the machine type and field of application and can affect the production capacity and quality. It can be provided that the operation of the textile machine is made possible by a user calling up the interface elements for outputting the machine parameters and/or other settings of the textile machine and/or for inputting, in particular the settings for the machine parameters and/or other settings.

According to a further advantage, it can be provided that the retrieval function comprises a search function. As a result, in the designations, it is possible to determine the designations that correspond to the retrieval specification in the form of a search specification. In other words, the search function can be designed to check whether the designations correspond to the retrieval specification or the search specification. The search specification can preferably comprise a search pattern and/or a search term and/or a similarity specification for the fuzzy search for a search term (i.e., a string of characters) and/or one or more initial letters of a designation to be searched for. Further criteria can be specified for satisfying the search specification, e.g., that the search term occurs at least partially in the designation. For example, the search specification can define that and/or to what extent the search pattern and/or the search term and/or the similarity specification and/or the initial letters occur in a designation so that the search specification corresponds to this designation. The search function can also be designed as a free text search and thus allow the user to search for any text in the designations.

Another possible design for the retrieval and/or search function is a tab. The tab can be displayed via a selectable selection menu and allows the user to switch directly to a page of the user interface by selecting directly from a list of designations in which the interface element of the selected designation occurs.

A further advantage can be achieved within the scope of the invention if the retrieval function determines a plurality of such designations that correspond to the retrieval specification. A plurality of designations can thus be available for selection by the user that correspond to the retrieval specification (e.g. start with a certain initial letter or have a certain string of characters). Advantageously, the determined designations are output as a list, preferably a selection list, on a common page of the user interface.

Furthermore, initiating the output can comprise the following steps, which are preferably executed in succession:
determining a frequency with which the interface elements assigned to the determined designations have been called up,
determining an order for the output of the determined designations for initiating the output of the determined designations sorted as a function of the determined frequency, preferably in such a way that the determined designation whose interface element was called up most frequently during a previous operation of the textile machine is output at first position.

This allows quick access to the most relevant interface elements. Logging of the number of call-ups of the interface elements during the operation of the textile machine can be provided in order to determine the frequency on the basis of the logged number. The log can, for example, be stored in a non-volatile memory of the apparatus according to the invention. The output can, for example, be initiated in such a way that the designations are sorted or listed in descending order of their frequency.

It is also optionally conceivable that the method further comprises: providing a selection function for the selection by the user in order to select at least or exactly one of the determined designations, preferably by initiating an output of a selection and/or navigation button for the corresponding determined designation, wherein preferably a selection action by the user is provided, in which the selection and/or navigation button is activated by the user, wherein particularly preferably the selection and/or navigation button is assigned a reference to one of the interface elements. The reference can be a characteristic of the interface element or a page of the user interface with the interface element that is assigned to the selection and/or navigation button in order to navigate to the interface element or the page when the selection and/or navigation button is actuated.

Furthermore, the method can comprise: providing the selection function, wherein for the determined designations, in the case of an identical designation occurring more than once, an output of an indication of a location of its interface elements is initiated in the user interface, preferably in a menu tree and/or the page of the user interface, in order to select the interface elements on the basis of the location. In particular in the case of identical designations, which, however, are assigned to different interface elements, optionally on different pages, this can allow the user to unambiguously identify the desired interface element. For this purpose, for example, each page and/or each entry in the menu tree can have a dedicated location designation, which is displayed in addition to the determined designations and can optionally be graphically assigned thereto (e.g. by an adjacent display and/or by displaying a message with the location designation if one of the designations is selected).

Furthermore, it can be provided within the scope of the invention that providing the navigation function comprises: initiating an output of a selection and/or navigation button for the corresponding determined designation in order to select the designation when the selection and/or navigation button is activated by the user, and/or to call up the interface element to which the determined designation selected by the user is assigned by initiating a display of the interface element on the user interface and/or by initiating the corresponding output of at least one machine parameter and/or at least one setting and/or by evaluating input by the user in order to preferably control the textile machine on the basis of the input, preferably to transmit a setting and/or data value to the textile machine. Furthermore, current setting and/or measured values of the textile machine can be determined and output by activation. It is also possible that a change of a page of the user interface is initiated to display the interface element.

In a further possibility, it can be provided that the interface elements comprise at least one of the following elements: an input element for inputting setting and/or data values for the textile machine, an output element for outputting setting and/or measured values of the textile machine, an action element for controlling the textile machine, a menu designation for menus of the at least one user interface, an alarm element for outputting an alarm of the textile machine. This allows for comprehensive operation of the textile machine via the user interface.

It is possible that the output of the determined designations, in particular in the form of a list, is initiated on a different page of the user interface than the pages of the user interface on which the interface elements thereof are displayed during the call-up. In other words, the output and preferably the listing of the determined designations, i.e., in particular of a search result of the call-up function, can take place on a different page of the user interface than the display of the associated interface elements, wherein the latter are optionally output on different pages. This has the advantage that even in the case of a complex structure of the user interface with a plurality of pages, it can be navigated quickly and conveniently using the retrieval function. The pages are preferably different, alternative views of the user interface, which in particular cannot be displayed simultaneously.

It can advantageously be provided within the scope of the invention that the following steps are provided:
receiving data from the textile machine, wherein the data indicate at least one setting and/or measured value of the textile machine and preferably result from a measurement of at least one machine parameter of the textile machine, for example by at least one sensor of the textile machine,
assigning the at least one setting and/or measured value to one of the interface elements,
initiating an output of the at least one setting and/or measured value when the assigned interface element is called up, wherein the corresponding interface element preferably displays the at least one setting and/or measured value in the form of a target and/or actual value of the machine parameter,
initiating an output of the designations assigned to the called-up interface element.

The designations can thus be designations of the interface elements that explain the function to the user. Intuitive operation of the textile machine is thus possible.

Furthermore, it is conceivable within the scope of the invention that the retrieval function comprises a search function for determining, in the machine parameters, preferably in the setting and/or measured values, those which correspond to the retrieval specification in the form of a search specification. In other words, alternatively or in addition to searching in the designations, it can also be possible to search in the setting and/or measured values using the search function. This can also comprise, for example, searching for certain states, such as critical states of the textile machine. For example, value ranges of the setting and/or measured values can also be searched for, for example critical value ranges or the like.

It is also possible for the retrieval specification to define a condition for the interface elements, wherein the retrieval function can check the designations to determine whether their interface elements satisfy the condition, wherein the condition preferably comprises an availability of a function of the interface element in the textile machine. In other words, it is possible to automatically check which functionality of the concrete textile machine is present, and to determine only the designations belonging to this functionality. This makes it possible to use the retrieval function for different textile machines with different functionality and/or for the textile machine in different states. The functionality and/or availability can, for example, be checked by querying a database in which the corresponding information is stored. When checking the condition, it is optionally also possible to check whether a certain component is present in the textile machine, such as a changer, in order to consider only the corresponding interface elements for setting this component and to determine the corresponding designations.

Furthermore, it is optionally provided that at least one of the following steps is provided:
evaluating a user search input in order to define the retrieval specification,
prompting the user to input the user search input.

The user search input can result from keyboard input and/or input via a touchscreen and/or voice input and/or gesture recognition and/or chatbot interaction. This allows for versatile and comfortable input of user-defined retrieval specifications.

According to a further possibility, it can be provided that the retrieval specification comprises a search pattern and/or a search term, wherein the following step can be executed: automatically supplementing the retrieval specification, preferably the user search input, with synonyms and/or similar search patterns and/or similar search terms in order to determine in the designations which designations correspond to one of the search patterns and/or search terms and/or synonyms of the supplemented retrieval specification. In other words, for the user-defined retrieval specification, which is based on the user input, additional specifications that make sense to complement the user input can be automatically determined. It is thus conceivable that a user uses an alternative designation in the search that is not displayed as such in the user interface. The search can be significantly simplified by adding other semantically identical or similar terms. It is conceivable that the addition of terms takes place on the basis of a term database. For this purpose, the term database can be queried, for example, based on the user input in order to output the corresponding synonyms for user input. The synonyms and/or similar search patterns and/or similar search terms can be covered by the term database. It is optionally also provided that the term database is automatically supplemented on the basis of user search inputs in a previous operation of the textile machine. In this way, the term database can be self-learning.

It is also advantageous if the retrieval function is provided on the basis of a machine learning algorithm. Such an algorithm can, for example, be pre-trained to determine certain designations on the basis of certain user inputs. For this purpose, for example, an artificial neural network can be trained with training data, wherein the training data comprise annotation data with a desired result. For example, a CNN (Convolutional Neural Network) can be used as a neural network. The annotation data can, for example, be manually specified for different exemplary user inputs of the training data.

The invention also relates to a system comprising an apparatus for data processing that comprises means for executing the method according to the invention, at least one textile machine that is in data connection with the apparatus in order to be operated by means of the user interface, and a display apparatus for outputting the user interface. Thus, the system according to the invention brings the same advantages as have been described in detail with reference to a method according to the invention.

An object of the invention is also an apparatus for data processing, comprising means for executing the steps of the method according to the invention. Thus, the apparatus according to the invention brings the same advantages as have been described in detail with reference to a method according to the invention.

An object of the invention is also a computer program, in particular a computer program product, comprising instructions that, when the computer program is executed by a computer, cause the computer to execute the method according to the invention. Thus, the computer program according to the invention brings the same advantages as have been described in detail with reference to a method according to the invention.

As the computer, an apparatus for data processing, for example, the apparatus according to the invention, which executes the computer program, can be provided. The computer can have at least one processor for executing the computer program. A non-volatile data memory can also be provided, in which the computer program can be stored and from which the computer program can be read by the processor for execution.

It is also conceivable that the computer comprises at least one integrated circuit, such as a microprocessor or an application-specific integrated circuit (ASIC) or an application-specific standard product (ASSP) or a digital signal processor (DSP) or a field-programmable gate array (FPGA) or the like. The computer can further have at least one interface for data exchange, such as an Ethernet interface or an interface for LAN (local area network) or WLAN (wireless local area network) or system-on-a-chip (SoC) or other radio interface such as Bluetooth or near-field communication (NFC). Further, the computer can be implemented as one or more control devices, i.e., also as a system of control devices. For example, the computer can also be provided in a cloud and/or as a server, in order to provide data processing for a local application via the interface. It is also possible that the computer is implemented as a mobile device, such as a smartphone.

An object of the invention can also be a computer-readable storage medium, which comprises the computer program according to the invention. The storage medium is designed, for example, as a data storage, such as a hard disk and/or a non-volatile memory and/or a memory card. The storage medium can, for example, be integrated into the computer.

In addition, the method according to the invention can also be executed as a computer-implemented method.

Further advantages, features and details of the invention will be apparent from the following description, in which exemplary embodiments of the invention are described in detail with reference to the drawing. The features mentioned in the claims and in the description can be substantial to the invention individually or in any combination.

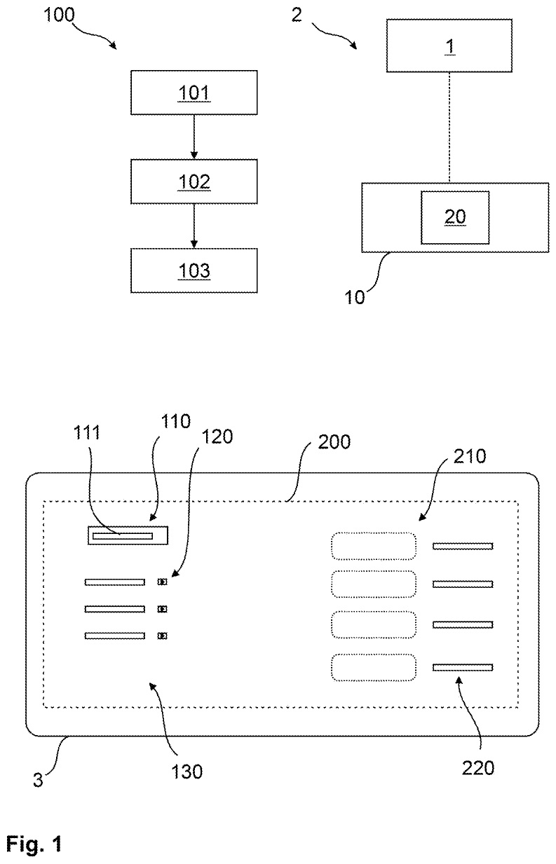

FIG. 1 shows, by way of example, a method 100 for monitoring and/or operating a textile machine 1. According to a first method step 101, a retrieval function 110 can be provided for at least one user interface 200. The at least one user interface 200 can thereby comprise a plurality of, in particular graphical, interface elements 210 that can be called up for outputting machine parameters and/or for the user to input settings. In this way, the interface elements 210 make it possible to monitor and/or operate the textile machine 1. In order to simplify operation and monitoring, a designation 220 can be assigned to each of the interface elements 210. The designation 220 describes, for example, the function of an interface element 210, for example by indicating a machine parameter or a setting that is output or input by the interface element 210. For this purpose, the designation 220 can be graphically displayed to the user together with the interface elements 210 via the user interface 200. Nevertheless, with a plurality of different interface elements 210 on optionally different pages of the user interface 200, it can be difficult for the user to quickly navigate to the desired interface element 210. The retrieval function 110 can therefore allow the designations 220 to be retrieved and in particular searched for based on a retrieval specification 111 in order to determine which designations 220 correspond to the retrieval specification 111. The retrieval specification 111 can be user-defined, i.e., can be actively input by the user in order to search for a certain designation 220.

According to a second method step 102, an output 130 of the determined designations 220 can be initiated via the at least one user interface 200 for selection by the user. According to a third method step 103, a navigation function 120 can be provided for the at least one user interface 200, wherein the navigation function 120 calls up the interface element 210 to which the designation 220 selected by the user is assigned.

The retrieval function 110 can comprise a search function 110 for determining the designations 220 in the designations 220 that correspond to the retrieval specification 111 in the form of a search specification 111. The search specification 111 can be a search pattern, i.e., specify certain character patterns that must occur in the designations 220. Likewise, the search specification 111 can define a search term that is searched for in the designations 220. Another possibility is to specify a similarity specification by the search specification 111 for the fuzzy search for a search term. In this case, small deviations such as spelling mistakes can be tolerated and still lead to a match of a designation 220 with the search specification 111. It is also possible to search for one or more initial letters of a designation 220 to be searched for. The search specification 111 can also define the extent to which the search pattern, the search term or the like must occur in the designation 220. For example, it can be predefined that the complete search term or even only a part thereof must be present in the designation 220 so that the designation 220 is determined and then output to the user.

In order to further simplify navigation through the user interface 200, a frequency can be determined with which the interface elements 210, to which the determined designations 220 are assigned, have previously been called up. The frequency can be used for different purposes. It is thus possible for those designations 220 whose interface elements 210 are most frequently called up to be given a higher priority. This can be done by determining an order for the output 130 of the determined designations 220 for initiating the output 130 of the determined designations 220 sorted as a function of the determined frequency. If the determined designation 220 whose interface element 210 was called up most frequently during a previous operation of the textile machine 1 is output at first position, this can lead to a more comfortable and faster access for the user. In order to determine the frequency during operation of the textile machine 1, the number of call-ups of the interface elements 210 during operation can be logged. For this purpose, for example, a counter that is incremented during each call-up can be assigned to each of the interface elements 210.

It is also possible for a selection function for the selection by the user to be provided in order to select at least or exactly one of the determined designations 220. The selection can be made, for example, by a selection action such as touching the designations 220 on a touchscreen. It is also possible for a selection and/or navigation button 120 to be output for the corresponding determined designation 220. This button can in each case have one of the designations 220 itself or be assigned to one of the designations 220. The selection and/or navigation button 120 can be activated by the user by means of the selection action in order to then call up the corresponding interface element 210 via a reference to one of the interface elements 210.

When the interface element 210 assigned to the designation 220 selected by the user is accessed, the interface element 210 can be displayed on the user interface 200 and the corresponding output of machine parameters can be initiated and/or input by the user. The call-up can also cause current setting and/or measured values of the textile machine 1 to be determined and output. For this purpose, for example, a query of sensors of the textile machine 1 can be provided, which are read out repeatedly and/or when triggered by the call-up. To determine the current setting and/or measured values, data can be received from the textile machine 1 and assigned to one of the interface elements 210 for this purpose. The determined data can be regarded as actual values, whereas the inputs of the user can be provided as target values for setting machine parameters.

A further embodiment of the retrieval function 110 is that of a search function 110 that determines, in the machine parameters, and preferably in the setting and/or measured values, those which correspond to the retrieval specification 111 in the form of a search specification 111. Thus, it is possible to search not (only) in the designations 220, but also in the setting and/or measured values of the interface elements 210 themselves. The user is thus able to search for certain settings or values.

In order to define the retrieval specification 111 by the user, the user can be prompted to input a user search input. This input can also be possible via the user interface, for example by an input by means of a keyboard and/or touchscreen and/or voice input and/or gesture and/or the like. Because the user may not know what a specific designation 220 is, the retrieval specification 111 can optionally also be automatically supplemented by synonyms and/or similar search patterns and/or similar search terms. These can then also be taken into account in the search. This supplementation can take place on the basis of a term database that comprises the synonyms and/or similar search patterns and/or similar search terms. The retrieval function 110 may expect alphanumeric input by the user.

It is also conceivable for the retrieval function 110 to be provided on the basis of a machine learning algorithm. In other words, the retrieval function 110 can have a search algorithm that is based on machine learning. For this purpose, training data can first be provided that contain search queries and associated relevant search results, i.e., the annotation data. A classifier can then be trained using the training data by means of a machine learning method. For example, decision trees, random forests, support vector machines (SVM) or neural networks are possible machine learning methods. In particular, when using a neural network as a machine learning method, backpropagation can be used, where the training data are fed as input into the network and the output of the network is compared to the actual relevant search results. Subsequently, the error can be calculated and the weights of the network can be adjusted using backpropagation in order to minimize the error. This process can be performed iteratively until the network has reached a high prediction accuracy. An example of a neural network that can be trained to predict the relevance of search results is a feedforward network having a plurality of layers of neurons. The input to the network can be, for example, characteristics of the search query, such as keywords, the user's search history, or the time of the search. The output of the network can be a probability distribution about the relevance of search results, which, for example, are taken from the available designations 220. The network can consist of a plurality of layers of neurons, each of which applies a nonlinear activation function such as the sigmoid function or the ReLU function to the weighted sum of the input. The output of the network can then be normalized by a softmax function in order to generate a probability distribution.

FIG. 1 shows an exemplary system 2 having an apparatus 10 for data processing, which apparatus comprises means for executing the method 100 according to exemplary embodiments of the invention. Furthermore, the system 2 can comprise at least one textile machine 1 that is in data connection with the apparatus 10 in order to be operated by means of the user interface 200. In addition, a display apparatus 3, such as a touchscreen, can be provided for outputting the user interface 200. Furthermore, a computer program 20 according to exemplary embodiments of the invention can be part of the apparatus 10.

The foregoing explanation of embodiments describes the present invention by way of example only. Of course, individual features of the embodiments can be freely combined with each other, if technically useful, without departing from the scope of the present invention.

### LIST OF REFERENCE SIGNS

1 Textile machine
2 System
3 Display apparatus
10 Apparatus, computer
20 Computer program
100 Method
101 First method step
102 Second method step
103 Third method step
110 Retrieval function
111 Retrieval specification
120 Navigation function, navigation button
130 Output
200 User interface
210 Interface elements
220 Designation

1. A method for monitoring and/or operating a textile machine, comprising the following steps:
providing a retrieval function for at least one user interface, wherein the at least one user interface comprises a plurality of interface elements that are called up for outputting machine parameters and/or settings of the textile machine and/or for input by a user in order thereby to monitor and/or operate the textile machine, wherein each of the interface elements is assigned a designation, wherein a retrieval of each designation is provided by the retrieval function on a basis of a retrieval specification in order to determine the designations that correspond to the retrieval specification, wherein the retrieval specification is defined by the user;
initiating an output of the designations via the at least one user interface for selection by the user; and
providing a navigation function for the at least one user interface, wherein the navigation function calls up one of the interface elements to which the designation selected by the user is assigned.

2. The method according to claim 1, wherein:
the retrieval function comprises a search function for checking whether the designations correspond to the retrieval specification in the form of a search specification, wherein the search specification comprises a search pattern and/or a search term and/or a similarity specification for a fuzzy search according to the search term and/or one or more initial letters of the designation to be searched for, wherein the search specification defines that and/or to what extent the search pattern and/or the search term and/or the similarity specification and/or the one or more initial letters occur in the designation so that the search specification corresponds to the designation.

3. The method according to claim 1, wherein the retrieval function determines a plurality of the designations which correspond to the retrieval specification, wherein initiating the output comprises the following steps:
determining a frequency with which the interface elements assigned to the designations have been called up; and
determining an order for the output of the designations for initiating the output of the designations sorted as a function of the determined frequency.

4. The method according to claim 3, further including:
logging a number of call-ups of the interface elements during an operation of the textile machine in order to determine the frequency on the basis of a logged number;
providing a selection function for a selection by the user in order to select at least one of the determined designations; and
providing the selection function, wherein for the determined designations, in a case of an identical designation occurring more than once, the output of an indication of a location of the interface elements thereof is initiated in the user interface in order to select the interface elements on a basis of the location.

5. The method according to claim 1, wherein providing the navigation function comprises the following step:
initiating an output of a selection and/or navigation button for a corresponding one of the designations in order to select the one of the designations when the selection and/or navigation button is activated by the user, and/or to call up the interface elements to which the designations selected by the user is assigned by initiating a display of the interface elements on the user interface and/or by initiating a corresponding output of at least one machine parameter and/or at least one setting and/or by evaluating an input by the user in order to control the textile machine on the basis of the input.

6. The method according to claim 1, wherein the interface elements comprise at least one of the following elements:
an input element for inputting setting and/or data values for the textile machine, an output element for outputting setting and/or measured values of the textile machine, an action element for controlling the textile machine, and a menu designation for menus of the at least one user interface.

7. The method according to claim 1, further including:
receiving data from the textile machine, wherein the data indicate at least one setting and/or measured value of the textile machine;
assigning the at least one setting and/or measured value to one of the interface elements;
initiating an output of the at least one setting and/or measured value when the interface elements assigned thereto are called up, wherein the interface elements corresponding thereto display the at least one setting and/or measured value in the form of a target and/or actual value of a machine parameter; and
initiating an output of the designations assigned to the interface elements that are called up.

8. The method according to claim 1, wherein the retrieval function comprises a search function for determining, in the machine parameters, those which correspond to the retrieval specification in the form of a search specification.

9. The method according to claim 1, further including:
evaluating a user search input in order to define the retrieval specification; and
prompting the user to input the user search input;
wherein the user search input results from keyboard input and/or touchscreen input and/or voice input and/or gesture recognition and/or chatbot interaction and/or
wherein the retrieval specification defines a condition for the interface elements, wherein the retrieval function checks the designations to determine whether their interface elements satisfy the condition.

10. The method according to claim 1, wherein the retrieval specification comprises a search pattern and/or a search term, and further including:
automatically supplementing the retrieval specification, with synonyms and/or similar search patterns and/or similar search terms in order to determine which of the designations correspond to the search pattern and/or search term and/or synonyms of the retrieval specification;
wherein the supplementing takes place on the basis of a term database that comprises the synonyms and/or similar search patterns and/or similar search terms.

11. The method according to claim 1, wherein the output of the designations is initiated on a different page of the user interface than the pages on which the interface elements thereof are displayed during a call-up.

12. The method according to claim 1, wherein the retrieval function is provided on the basis of a machine learning algorithm.

13. A system having:
an apparatus for data processing, comprising means for executing the method according to claim 1;
at least one textile machine that is in data connection with the apparatus in order to be operated by the user interface; and
a display apparatus for outputting the user interface.

14. A computer program comprising instructions that, when the computer program is executed by a computer, cause the computer to execute the method according to claim 1.

15. An apparatus for data processing, comprising means for executing the method according to claim 1.

16. The method according to claim 3, wherein the designation whose interface element was called up most frequently during a previous operation of the textile machine is output at a first position.

17. The method according to claim 4, wherein providing the selection function includes initiating an output of a selection and/or navigation button for the designation corresponding thereto and wherein a selection action by the user is provided, in which the selection and/or navigation button is activated by the user, wherein the selection and/or navigation button is assigned a reference to one of the interface elements.
